(19) United States
(12) Patent Application Publication
(10) Pub. No.: US 2008/0170685 A1
(43) Pub. Date: Jul. 17, 2008

(54) Data scrambling circuit

(75) Inventors: Lance Flake, Longmont, CO (US); Brent Mulholland, Boulder, CO (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/655,685

(22) Filed: Jan. 19, 2007

Related U.S. Application Data
(60) Provisional application No. 60/885,019, filed on Jan. 16, 2007.

(51) Int. Cl. H04L 9/28

(52) U.S. Cl. 380/28

(57) ABSTRACT

A data scrambling circuit is provided. The data scrambling circuit includes an integrated circuit having a digital logic device and an interface circuit coupled to the digital logic device. Also included is an external memory coupled to output pins on the interface circuit. The digital logic device communicates patterned data to the interface circuit. The interface circuit then scrambles the patterned data to produce a pseudo random output to be stored within the external memory and unscrambled a pseudo random signal from the external memory to produce unscrambled data to be read by the digital logic device.

### RELATED APPLICATIONS

This application claims priority to and incorporates by reference in its entirety for all purposes U.S. Provisional Application No. 60/885,019 filed on 16 Jan. 2007 entitled “DATA SCRAMBLING CIRCUIT”.

### TECHNICAL FIELD OF THE INVENTION

Embodiments of the present invention relate generally to memory storage devices; and, more particularly embodiments of the present invention relate to data scrambling circuits of memory storage devices.

### BACKGROUND OF THE INVENTION

As is known, many varieties of memory storage devices (e.g. disk drives), such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

The structure and operation of hard disk drives is generally known. Hard disk drives include, generally, a case, a hard disk having magnetically alterable properties, and a read/write mechanism including Read/Write (RW) heads operable to write data to the hard disk by locally alerting the magnetic properties of the hard disk and to read data from the hard disk by reading local magnetic properties of the hard disk. The hard disk may include multiple platters, each platter being a planar disk.

All information stored on the hard disk is recorded in tracks, which are concentric circles organized on the surface of the platters. FIG. 1 depicts a pattern of radially-spaced concentric data tracks 12 within a disk 10. Data stored on the disks may be accessed by moving RW heads radially as driven by a head actuator to the radial location of the track containing the data. To efficiently and quickly access this data, fine control of RW hard positioning is required. The track-based organization of data on the hard disk(s) allows for easy access to any part of the disk, which is why hard disk drives are called “random access” storage devices.

Since each track typically holds many thousands of bytes of data, the tracks are further divided into smaller units called sectors. This reduces the amount of space wasted by small files. Each sector holds 512 bytes of user data, plus as many as a few dozen additional bytes used for internal drive control and for error detection and correction.

Within such hard disk drives (HDDs), disk drive controllers control the various processes associated with the read/write of data to the physical media. These disk drive controllers may comprise digital logic devices that include both a processor and memory device wherein the memory device is separate from the digital logic device. This memory may serve as the read write (RW) buffer in a HDD controller. In this architecture data is written to and read from the external memory device. This requires drivers to drive the external pins that are used to couple the digital logic device to the memory device. As a large number of memory bits may be driven simultaneously, the switching of the memory bits can result in high instantaneous currents which may create electromagnetic interference (EMI) problems associated with these current spikes. These current spikes and EMI problems may be exacerbated by the non-random nature of much of the data written to and read from the memory device. The repetitive data simultaneously changing may result in an overall amplification of the EMI signature at high frequencies.

During a write, the interface circuit switching may result in increased EMI signatures associated with the write. Similarly on a read, the pins of a memory device, when the data is patterned, may result in increased EMI signature as well. This simultaneous switching in addition to creating an EMI problem also may draw a large amount of current instantaneously. These may result in a ground bounce or a voltage droop. In addition to a current or EMI problem, security problem exists wherein it may be possible to read the data from the pins of either the digital logic device used to drive the external memory device or the memory device itself. As the amount and frequency of data read and written to memory increase, the potential for the above identified problems (i.e. EMI, current spikes and security risks) increase.

### SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts a prior art pattern of radially-spaced concentric data tracks within the magnetic media of a disk;

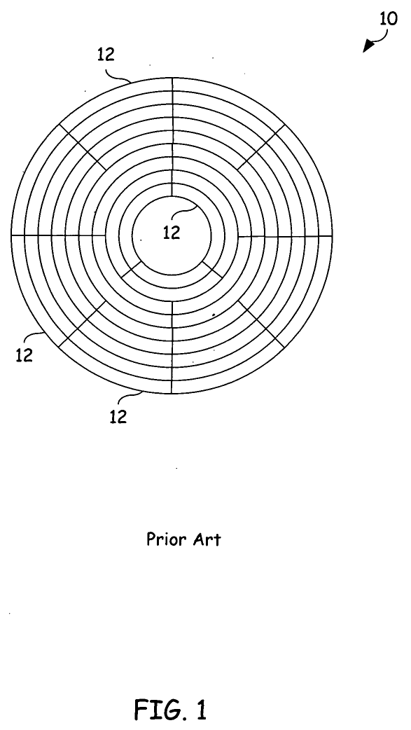

FIG. 2 illustrates an embodiment of a disk drive unit in accordance with embodiments of the present invention;

FIG. 3 illustrates an embodiment of a disk controller 130 in accordance with embodiments of the present invention;

FIGS. 4A through 4E illustrate various devices that employ hard disk drives unit in accordance with embodiments of the present invention;

FIG. 5 is a block diagram of a system using the data scrambling circuit in accordance with embodiments of the present invention;

FIG. 6 provides a block diagram of interface circuitry in further detail in accordance with embodiments of the present invention;

FIG. 7 provides a logic flow diagram that describes a method operable to scramble data in accordance with the embodiments of the present invention;

FIG. 8 provides a logic flow diagram depicting a method with which to unscramble data in accordance with embodiments of the present invention.

### DETAILED DESCRIPTION OF THE INVENTION

Preferred embodiments of the present invention are illustrated in the FIGs., like numerals being used to refer to like and corresponding parts of the various drawings.

Embodiments of the present invention provide a data scrambling circuit. The data scrambling circuit includes an integrated circuit having a digital logic device and an interface circuit coupled to the digital logic device. Also included is an external memory coupled to output pins on the interface circuit. The digital logic device communicates patterned data to the interface circuit. The interface circuit then scrambles the patterned data to produce a pseudo random output to be stored within the external memory and unscrambled a pseudo random signal from the external memory to produce unscrambled data to be read by the digital logic device.

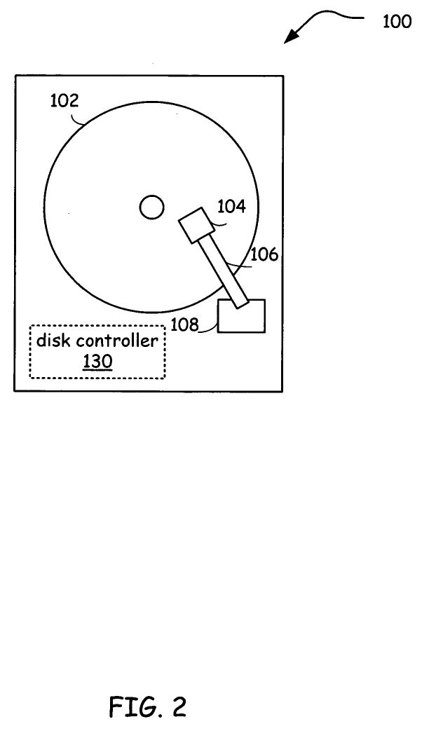

FIG. 2 illustrates an embodiment of a disk drive unit 100 that may utilize an embedded trace system in accordance with embodiments of the present invention. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM, however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

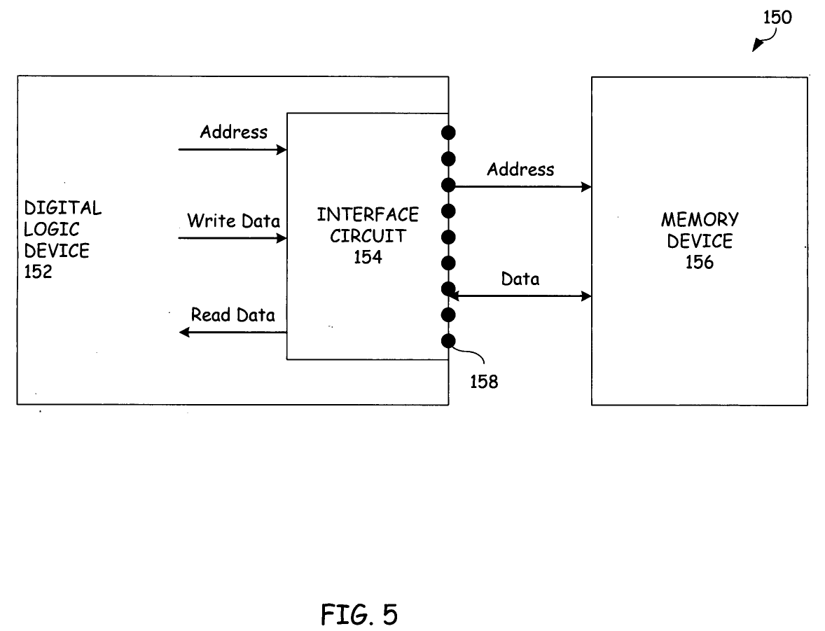

Disk drive unit 100 further includes one or more read/write heads 104 that are coupled to arm 106 that is moved by actuator 108 over the surface of the disk 102 either by translation, rotation or both. A disk controller 130 is included for controlling the read and write operations to and from the drive, for controlling the speed of the servo motor and the motion of actuator 108, and for providing an interface to and from the host device. Embedded trace systems within disk controller 130 will be discussed with reference to FIG. 5 and following.

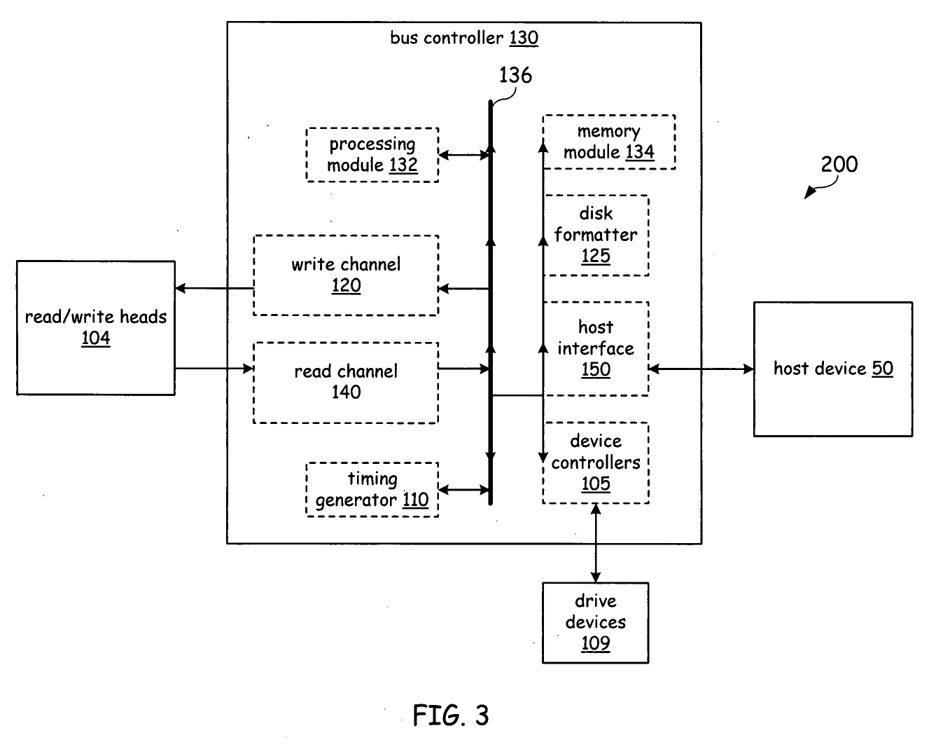

FIG. 3 illustrates an embodiment of a disk controller 130. Disk controller 130 includes a read channel 140 and write channel 120 for reading and writing data to and from disk 102 through read/write heads 104. Disk formatter 125 is included for controlling the formatting of disk drive unit 100, timing generator 110 provides clock signals and other timing signals, device controllers 105 control the operation of drive devices 109 such as actuator 108 and the servo motor, etc. Host interface 150 receives read and write commands from host device 50 and transmits data read from disk 102 along with other control information in accordance with a host interface protocol. In one possible embodiment, the host interface protocol can include, SCSI, SATA, enhanced integrated drive electronics (EIDE), or any number of other host interface protocols, either open or proprietary, that can be used for this purpose.

Disk controller 130 further includes a processing module 132 and memory module 134. Processing module 132 can be implemented using one or more microprocessors, micro-controllers, digital signal processors (DSPs), microcomputers, central processing units (CPUs), field programmable gate arrays (FPGAs), programmable logic devices (PLAs), state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory (ROM), random access memory (RAM), volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps or a process, method and/or function illustrated herein.

Disk controller 130 includes a plurality of modules, in particular, device controllers 105, processing timing generator 110, processing module 132, memory module 134, write channel 120, read channel 140, disk formatter 125, and host interface 150 that are interconnected via bus 136. Each of these modules can be implemented in hardware, firmware, software or a combination thereof, in accordance with the broad scope of the present invention. While the particular bus architecture is shown in FIG. 3 with a single bus 136, alternative bus architectures that include additional data buses, further connectivity, such as direct connectivity between the various modules, are likewise possible to implement additional features and functions.

In one possible embodiment, one or more (possible all) modules of disk controller 130 are implemented as embedded systems within a system on a chip (SOC) integrated circuit. In such a possible embodiment, this SOC integrated circuit includes a digital portion that can include additional modules such as protocol converters, linear block code encoding and decoding modules, etc., and an analog portion that includes device controllers 105 and optionally additional modules, such as a power supply, etc. In an alternative embodiment, the various functions and features of disk controller 130 are implemented in a plurality of integrated circuit devices that communicate and combine to perform the functionality of disk controller 130. To monitor the operations of these modules, embedded trace systems may be implemented within the integrated circuit.

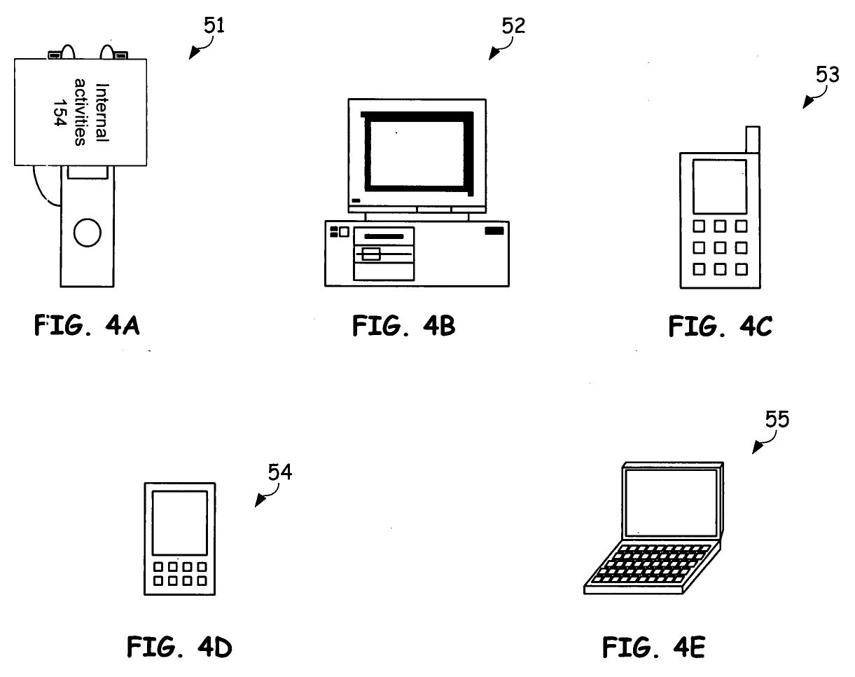

FIGS. 4A through 4E illustrate various devices that employ hard disk drives unit in accordance with embodiments of the present invention. FIG. 4A illustrates an embodiment of a handheld audio unit 51. In particular, disk drive unit 100 can be implemented in the handheld audio unit 51. In one possible embodiment, the disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 4B illustrates an embodiment of a computer 52. In particular, disk drive unit 100 can be implemented in the computer 52. In one possible embodiment, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 4C illustrates an embodiment of a wireless communication device 53. In particular, disk drive unit 100 can be implemented in the wireless communication device 53. In one possible embodiment, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In a possible embodiment, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 4D illustrates an embodiment of a personal digital assistant (PDA) 54. In particular, disk drive unit 100 can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

FIG. 4E illustrates an embodiment of a laptop computer 55. In particular, disk drive unit 100 can be implemented in the laptop computer 55. In one possible embodiment, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

A data scrambling circuit is provided by embodiments of the present invention. The data scrambling circuit provides an integrated circuit having a digital logic device and an interface circuit coupled to the digital logic device. Also included is an external memory coupled to output pins on the interface circuit. The digital logic device communicates patterned data to the interface circuit. The interface circuit then scrambles the patterned data to produce a pseudo random output to be stored within the external memory and unscrambles a pseudo random signal from the external memory to produce unscrambled data to be read by the digital logic device.

FIG. 5 is a block diagram of a system using the data scrambling circuit in accordance with embodiments of the present invention. Data scrambling circuit system 150 may be a disc controller for an HDD or other like device that operates on patterned data.

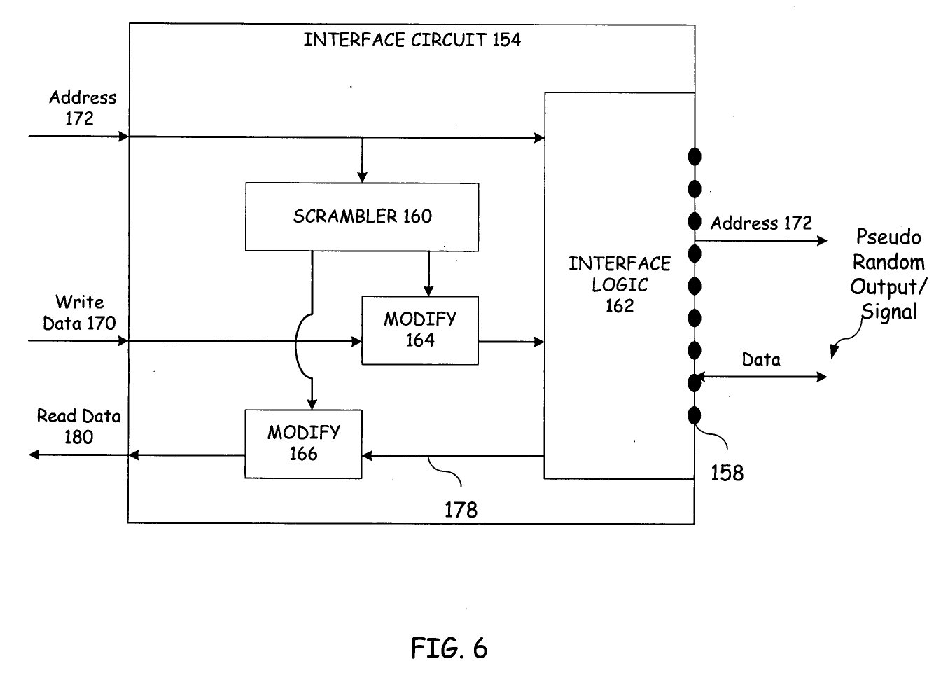

Such a data scrambling circuit may be employed where large amounts of high frequency patterned data are written to and from external memory such as within a hard disk controller or a graphics controller. Data scrambling circuit 150 includes a digital logic device 152, interface circuitry 154 and memory external memory device 156. The digital logic device provides addresses with which to read and write patterned data such as that seen in a hard disk drive controller or graphics controller to the interface circuitry which will be described in further detail with reference to FIG. 6. Interface circuitry 154 is coupled the output pins to external output pins 158 to external memory device 156.

A digital logic device has a set of pins 158 to connect to an external memory device such as a DRAM and SRAM. The data scrambling circuit exists in the logic device on the data path between the internal interface circuit and the pins. Internal functions request memory read and write accesses through the interface circuit. Each access request can be for a single location or a sequential set of locations. The (beginning) address of the access is presented to the data scrambling circuit for a seeding function.

FIG. 6 provides a block diagram of interface circuitry in further detail. Interface circuitry 154 includes scrambler 160, interface logic 162, modified circuitry 164 and 166 as well as output pins 158. Interface circuitry 154 receives an address 172 of data to be accessed from digital logic device 152. This may involve both the writing of data and the reading of data to the external memory device. When writing data the patterned data 170, modified circuitry 164 uses a pseudo random counter produced by scrambler 160 to randomize the data. This pseudo random counter may be seeded by address 172. Address 172 and pseudo random output 174 are provided to interface logic 162 which drives output pins 158. This allows the output on pins 158 to be of a pseudo random nature in order to reduce EMI concerns, security concerns, potential voltage droop, and current spikes. This pseudo random output and address 172 are provided to external memory 156.

In the case of a read, the digital logic device again will specify address 172 of the pseudo random signal to be read from external memory device 156. Interface logic will read pseudo random signal 176 from external memory using address 172. Again, a pseudo random signal is seen on the pins 158 which again results in reduced EMI concerns, security concerns, voltage droop and current spikes. The interface logic will output the pseudo random signal 178 to modify circuitry 166 which may use the pseudo random counter generated using address 172 to produce unscrambled data 180 which is then read by the digital logic device.

Data scrambling circuit 150 reduces electromagnetic interference (EMI) generated by an external memory device 156 interfaced to digital logic device 152. The scrambling circuit uses each memory access (beginning) address as a seed for an effective yet repeatable scrambling function.

The (beginning) address of the access to/from the memory device is used as a seed into the scrambling function. The function output is then used to modify write data before it reaches the interface outputs (and thus the memory device). Each data value within a set is modified by a new, distinct value from the scrambling function. The read data from the memory device is modified in a similar fashion by the same scrambling function with an inverse effect to obtain the un-scrambled data.

The scrambling function can be as simple or complex as desired by the system requirements. To effectively reduce EMI the data presented at the device pins should be close to random despite inherent fixed pattern-generated frequencies. A pseudo-random counter seeded by the address is the preferred implementation of the scrambling function. The counter output is XOR'ed with the data to perform the modification function for writes and reads.

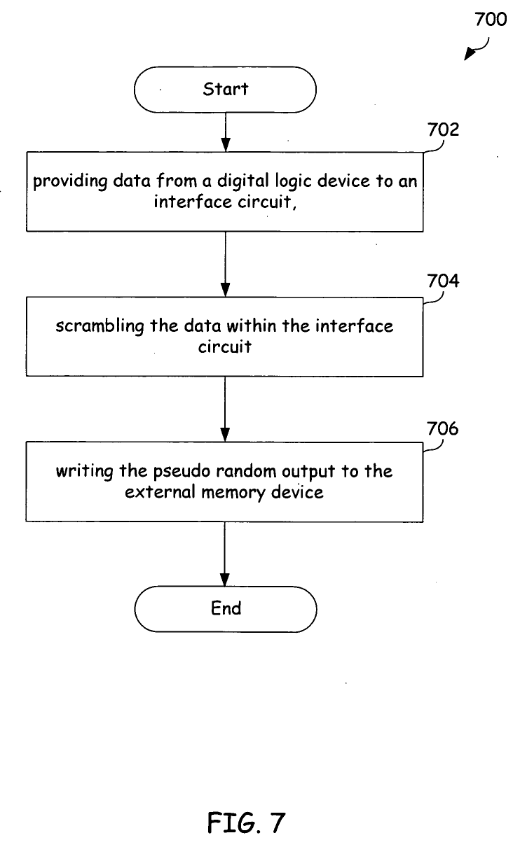

FIG. 7 provides a logic flow diagram that describes a method operable to scramble data in accordance with the embodiments of the present invention. Operations 700 begin with a digital logic device providing data to an interface circuit in Step 702. This data is to be written to an external memory device. In Step 704 the data which may be scrambled data may be scrambled within the interface circuit to produce a pseudo random output. As previously described a pseudo random output will result in reduced EMI signatures, security concerns, voltage droop and current spikes by providing a pseudo random output to an external memory device when compared to providing a patterned data output to an external memory device. In Step 706 the pseudo random output is written to the external memory device.

Scrambling the data within the interface circuit may use a scrambling function to produce the pseudo random output. This scrambling function may be seeded using an address of data to the external memory. The scrambling function typically will produce a pseudo random counter which may be XOR'ed with the data to be written to external memory in order to produce the pseudo random output. Additionally the address of the data may be scrambled as well. This scrambling function may employ a cyclic redundancy check (CRC) algorithm or linear feedback shift register (LFSR) or other like means known to those having skill in the art to reduce a pseudo random output from a substantially patterned data.

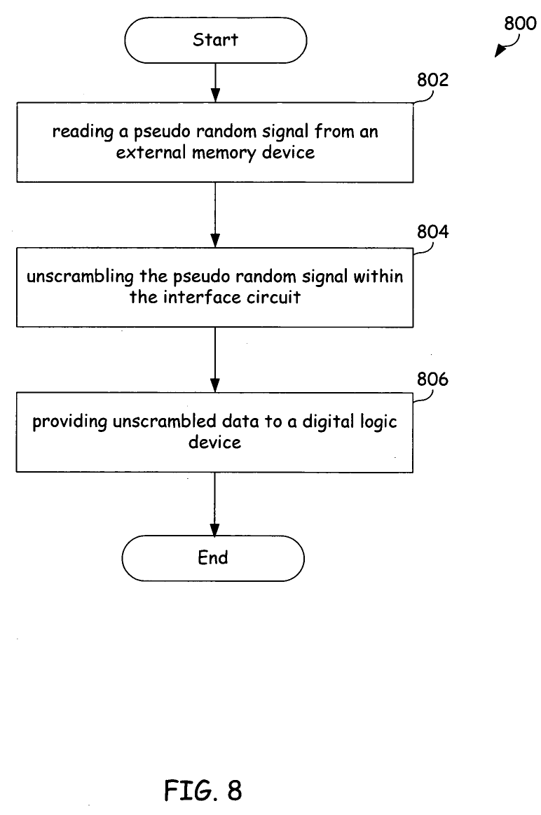

FIG. 8 provides a logic flow diagram depicting a method with which to unscramble data in accordance with embodiments of the present invention. Operations 800 begin by reading a pseudo random signal from an external memory device with an interface circuit. The pseudo random nature of the signal allows the EMI, security, voltage droop, and current spike concerns associated with providing the pseudo random signal to the pin of an interface circuit to be reduced. The interface circuit in Step 804 unscrambles the pseudo random signal to produce unscrambled data. In Step 806 this unscrambled data can then be provided to the digital logic device.

An unscrambling function similar to the scramble function may be used to produce the unscrambled data from this pseudo random signal. This unscrambling function may be seeded using an address of the pseudo random signal within the external memory. This unscrambling function may produce a pseudo random encounter which may be XOR'ed with the pseudo random signal to produce the unscrambled data. This allows the pseudo random signal or output stored in an external memory such as DRAM or SRAM to be provided to the digital logic device with benefits as previously discussed.

In summary, the present invention provides a data scrambling circuit. The data scrambling circuit includes an integrated circuit having a digital logic device and an interface circuit coupled to the digital logic device. Also included is an external memory coupled to output pins on the interface circuit. The digital logic device communicates patterned data to the interface circuit. The interface circuit then scrambles the patterned data to produce a pseudo random output to be stored within the external memory and unscrambled a pseudo random signal from the external memory to produce unscrambled data to be read by the digital logic device.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions and alterations can be made hereto without departing from the spirit and scope of the invention as described by the appended claims.

What is claimed is:

1. A method operable to scramble data, comprising:
providing data from a digital logic device to an interface circuit, wherein the data is to be written to an external memory device;
scrambling the data within the interface circuit to produce a pseudo random output; and
writing the pseudo random output to the external memory device.

2. The method of claim 1, wherein scrambling the data uses a scrambling function to produce the pseudo random output wherein the scrambling function is seeded using an address of the data to be written to external memory.

3. The method of claim 1, wherein a hard disk controller comprises the digital logic device and external memory device.

4. The method of claim 1, wherein scrambling the data XOR's the data to be written to external memory with a pseudo-random counter to produce the pseudo random output.

5. The method of claim 1, wherein the external memory device comprises a DRAM or SRAM.

6. The method of claim 1, wherein scrambling the data comprises scrambling data and an address of the data to be written to external memory.

7. The method of claim 1, wherein scrambling the data uses a scrambling function to produce the pseudo random output wherein the scrambling function employs a cyclic redundancy check (CRC) algorithm or a linear feedback shift register (LSFR).

8. The method of claim 1, wherein power required to write the pseudo random output to the external memory device is reduced by a pseudo random nature of the pseudo random output.

9. The method of claim 1, wherein a graphics controller comprises the digital logic device and external memory device.

10. A method operable to unscramble data, comprising:
reading a pseudo random signal from an external memory device with an interface circuit;
unscrambling the pseudo random signal within the interface circuit to produce the unscrambled data; and
providing unscrambled data to a digital logic device.

11. The method of claim 10, wherein unscrambling the data uses an unscrambling function to produce the unscrambled data from the pseudo random signal wherein the scrambling function is seeded using an address of the pseudo random signal within the external memory.

12. The method of claim 10, wherein a hard disk controller comprises the digital logic device and external memory device.

13. The method of claim 10, wherein a graphics controller comprises the digital logic device and external memory device.

14. The method of claim 10, wherein unscrambling the data XOR's a pseudo-random counter with the pseudo random signal to produce the unscrambled data.

15. The method of claim 10, wherein the external memory device comprises a DRAM or SRAM.

16. The method of claim 10, wherein unscrambling the data uses an unscrambling function wherein the unscrambling function employs a cyclic redundancy check (CRC) algorithm or a linear feedback shift register (LSFR).

17. A data scrambling circuit comprising:
an integrated circuit comprising:
a digital logic device; and
an interface circuit coupled to the digital logic device; and
an external memory coupled to output pins of the interface circuit; and wherein:
the digital logic device communicates patterned data to the interface circuit;
the interface circuit scrambles the patterned data to produce a pseudo random output to be stored within the external memory and unscrambles a pseudo random signal from the external memory to produce unscrambled data to be read by the digital logic device.

18. The data scrambling circuit of claim 17, wherein:
scrambling the data uses a scrambling function to produce the pseudo random output wherein the scrambling function is seeded using an address of the data to be written to external memory; and
unscrambling the data uses an unscrambling function to produce the unscrambled data from the pseudo random signal wherein the scrambling function is seeded using an address of the pseudo random signal within the external memory

19. The data scrambling circuit of claim 17, wherein a hard disk controller comprises the data scrambling circuit.

20. The data scrambling circuit of claim 17, wherein a graphics controller comprises the data scrambling circuit.

21. The data scrambling circuit of claim 17, wherein:
scrambling the patterned data XOR's the patterned data to be written to external memory with a pseudo-random counter to produce the pseudo random output; and
unscrambling the data XOR's the pseudo-random counter with the pseudo random signal to produce the unscrambled data.

22. The data scrambling circuit of claim 17, wherein the external memory device comprises a DRAM or SRAM.

23. The data scrambling circuit of claim 17, wherein:
scrambling the data uses a scrambling function to produce the pseudo random output wherein the scrambling function is seeded using an address of the data to be written to external memory; and
unscrambling the data uses an unscrambling function to produce the unscrambled data from the pseudo random signal wherein the scrambling function is seeded using an address of the pseudo random signal within the external memory; and
the scrambling function/unscrambling function employs a cyclic redundancy check (CRC) algorithm or a linear feedback shift register (LSFR).
